(19) United States
(12) Patent Application Publication
(10) Pub. No.: US 2002/0147848 A1
(43) Pub. Date: Oct. 10, 2002

(54) System and method for enabling communication between browser frames

(76) Inventors: Daniel Keele Burgin, Boulder, CO (US); David L. Young, Boulder, CO (US); William Randy Watler, Evergreen, CO (US); Jonathan Phillips, Golden, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/945,032

(22) Filed: Aug. 31, 2001

Related U.S. Application Data
(60) Provisional application No. 60/281,637, filed on Apr. 5, 2001.

(51) Int. Cl. G06F 15/16

(52) U.S. Cl. 709/246; 709/219

(57) ABSTRACT

A system and method for displaying content in a browser window associated with an end-user is described. In one embodiment, content that corresponds to a navigation location is retrieved. This content includes an embedded navigation link that can be extracted and encoded. Next, the embedded navigation link can be replaced by the encoded navigation link. Finally, the retrieved content, including the encoded navigation link, can be provided to the browser.

This application claims priority from the U.S. Provisional Patent Application No. 60/281,637, entitled Integrated Automated and Live Electronic Customer Service Application and Method, filed on Apr. 5, 2001.

### RELATED APPLICATIONS

This application is related to the following commonly owned and assigned U.S. patents, all of which are expressly incorporated herein by reference:

U.S. Pat. No. 6,201,948, entitled Agent Based Instruction System and Method; and

U.S. Pat. No. 5,727,950, entitled Agent Based Instruction System and Method.

### FIELD OF THE INVENTION

The present invention relates to systems and methods for operating web browsers. In particular, but not by way of limitation, the present invention relates to systems and methods for making event information associated with a first frame of a web browser available to a second frame of the web browser.

### BACKGROUND OF THE INVENTION

The Internet and ecommerce Web sites are radically altering the way that many businesses operate. In particular, ecommerce Web sites are altering the relationship between buyers and sellers. Sellers, for example, can realize substantial cost savings by moving buyers from their brick-and-mortar stores to their ecommerce Web sites. Unfortunately, the full potential of these ecommerce Web sites is not being realized because of poor customer experiences while using them.

Statistics show that the majority of sales initiated on an ecommerce Web site are abandoned before completion. Often these transactions are abandoned because the customer has reached some impasse such as a site navigation problem or an unanswered product question. Some businesses address these customer issues by providing live customer support. Live customer support, however, is relatively expensive and, thus, negates much of the cost savings offered by ecommerce. Additionally, when live customer support only provides for email response, customers often abandon transactions before receiving an email response.

Because live customer support is relatively expensive, many businesses elect to use online, non-live support either exclusively or in conjunction with some type of live help. Most of these types of non-live support systems are form-based instruction manuals. In other words, the customer is given a list of frequently asked questions (FAQs) from which to select. Assuming that the customer's question is in the list of FAQs, these types of support systems return the corresponding answer in a text-based format. Rather than navigate such an instruction manual, many users simply terminate the transaction or contact the live customer support. In either case, the business associated with the ecommerce Web site loses important revenue.

Some non-live support systems attempt to present an animated character to address the customer's issues. These characters are generally little more than animated instruction manuals and lack the “look and feel” of live help. Again, rather than deal with such an annoying and unhelpful character, many customers terminate the transaction or contact live customer support. Moreover, these present systems are generally rigid and typically cannot be easily transported from one ecommerce site to another. Thus, these present non-live systems are not only unsatisfactory from the customer's perspective, they are expensive to develop and modify from the ecommerce business's perspective.

Another issue with present systems is their inability to communicate event information between frames that contain content originating from different domains. In particular, security protocols, e.g., consistent page domain security requirements, prevent such interaction. These protocols prevent processes operating in one frame from monitoring or controlling processes executing in another frame and, thus, limit the design options for end-user support systems.

As ecommerce becomes more competitive, successful businesses will retain a higher percentage of customers while spending a minimum amount of money on customer support. Businesses are losing precious revenues because present technologies do not sufficiently minimize customer support costs while retaining customers. Accordingly, a system and method are needed to address the above-mentioned and other shortfalls in present technology.

### SUMMARY OF THE INVENTION

Exemplary embodiments of the present invention that are shown in the drawings are summarized below. These and other embodiments are more filly described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the present invention provides a system and method for making event information associated with a first frame of a web browser available to a second frame of the web browser. Such a method includes, for example, the steps of retrieving content, such as a web page, that corresponds to a navigation location. This retrieved content generally includes an embedded navigation link that can be extracted and encoded. Next, the embedded navigation link can be replaced with the encoding of the embedded navigation link. Finally, the retrieved, including the replaced navigation link, can be provided to the user for viewing.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a system constructed in accordance with an embodiment of the present invention;

FIG. 2 illustrates an alternate system also constructed in accordance with an embodiment of the present invention;

FIG. 3 is a flowchart showing one method of operating the system shown in FIG. 2;

FIG. 4 illustrates yet another system constructed in accordance with an embodiment of the present invention;

FIG. 5 is a flowchart showing one method of operating the system shown in FIG. 4;

FIG. 6 illustrates the interaction of the annotation server and the browser; and

FIG. 7 is a flowchart showing one method of operating the annotation server.

### DETAILED DESCRIPTION

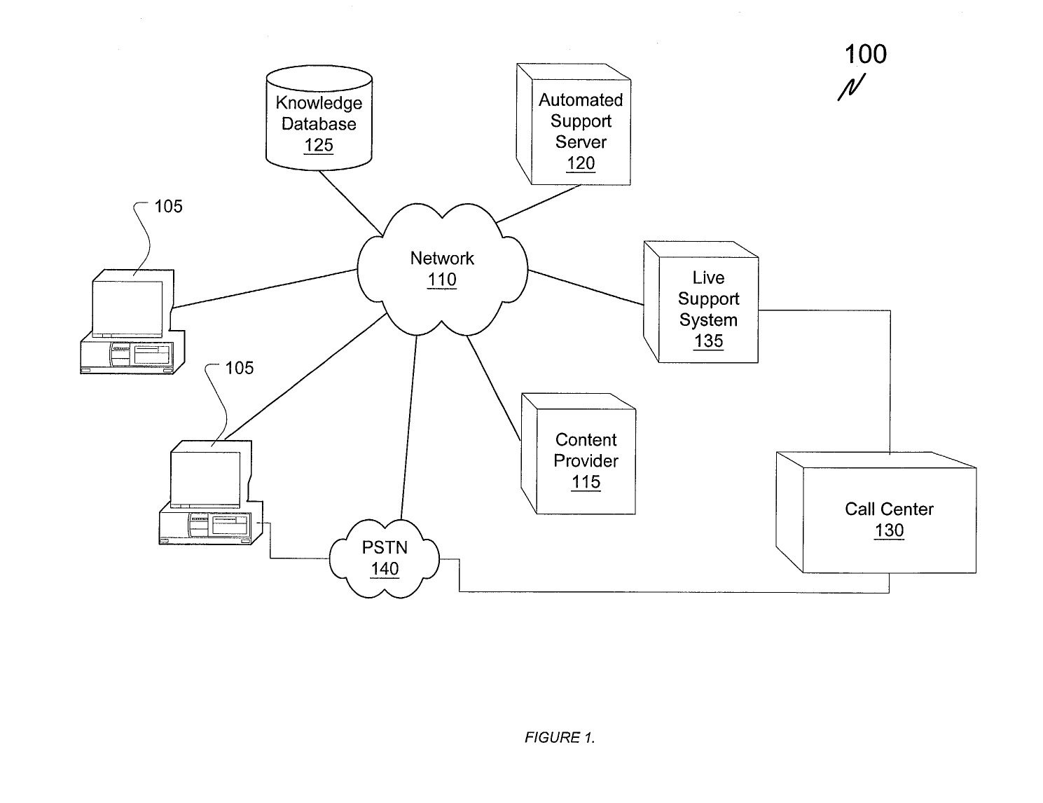

Referring now to the drawings, where like or similar elements are designated with identical reference numerals throughout the several views, and referring in particular to FIG. 1, there is illustrated a system 100 constructed in accordance with the principles of the present invention. This system 100 includes a plurality of end-users 105 connected through a network 110, such as the Internet, to a content provider 115, such as an ecommerce Web site. Any of the end-users 105 can access the content provider 115 through the network 110, and when necessary, an end-user 105 can also access an automated support server 120 for support. In one implementation, automated support 120 is manifested by an automated agent that is displayed in the end-user's browser window in conjunction with content from the content provider 115.

The automated agent is preferably generated by the automated support server 120 and is generally aware of the end-user's personal information, metadata associated with the content provider 115, the end-user's navigation location within a Web site, and navigation events initiated by the end-user 105. For example, if the end-user 115 follows a particular link in a Web page provided by the content provider 115, the automated agent—via the automated support server 120—can be aware of that fact and can also be aware of the next page from the content provider 115 that will be displayed for the end-user 105. Through this awareness of navigation events, the automated agent provides the end-user with an interactive and intelligent support session rather than just a list of questions and answers.

To generate the automated agent and to drive its interaction with the end-user 105, the automated support server 120 can use information stored in the knowledge database 125. This information can include data about the end-user 105, predefined character traits of the automated agent, and/or interaction management data. Further, this type of information can include role definitions and skill definitions. For example, the automated agent can be associated with a particular role such as greeter, product advisor, process accompaniment, customer service, etc., that define the boundaries of the automated agent's behavior. Each of these roles includes a possibly distinct set of skills that manage the automated agent's interaction with the end-user 105. One set of skills might define the social aspects of the automated agent and another set of skills might manage the flow of data between the automated agent, the knowledge database 125, and the end-user 105. For example, a “get order status” skill could retrieve order information from the end-user 105, pass that information to the knowledge database 125, receive corresponding order status information from the knowledge database 125, and provide that order status information to the end-user 105.

If the end-user 105 needs additional help or if the automated agent determines that an alternative support session is necessary or would be beneficial, the automated agent can automatically escalate the help session to involve, for example, live agents at a call center 130 or at any other location. The live support session could be conducted through the live support server 135 with video and/or audio streaming, chat sessions, Voice-over-IP channels, and/or email. The live support sessions can also be conducted through a traditional phone call routed to the call center 130 through, for example, a public switch telephone network (PSTN) 140.

When a live help session is initiated, the live agent can access the knowledge database 125 and/or the automated support server 120 to collect data about the end-user 105 and the end-user's session with the automated support server 120. Accordingly, the transition from the automated agent to the live agent can be somewhat seamless. Additionally, the live agent can work in conjunction with the automated agent to address the end-user's questions. In this implementation, the automated agent could run in the background and not be visible to the end-user 105. Even though it is not necessarily visible, the automated agent can gather information, for example, about the end-user's present location within a Web page and subsequent navigation events. This information can be passed to the live agent to provide a more complete understanding of the enduser's situation.

Additionally, once the live agent has addressed the end-user's question, the end-user 105 can be passed back to the automated agent, i.e., the automated support server 120. The automated agent can remember the end-user's previous session and interact with the end-user 105 accordingly. In some implementations, the automated agent can even be provided with details related to the end-user's interaction with the live agent. Thus, the transition from the live agent back to the automated agent could appear virtually seamless to the end-user 105.

To improve the responsiveness of the automated agent, details regarding endusers' sessions can be logged and analyzed. In particular, the details regarding the interaction between live agents and end-users 105 can be logged and analyzed. For example, when the automated agent refers an end-user 105 to a live agent, the question raised by the end-user 105 can be recorded. This question and a corresponding answer can then be added to the knowledge database 125 so that the automated agent can answer the question in the future without the aid of a live agent. In other implementations, an event record is created when an end-user 105 terminates the automated agent before the end-user's question is addressed. These event records can be aggregated to determine if the automated agent is being unresponsive and to determine what updates should be made to the knowledge database 125 or to the automated support server 120.

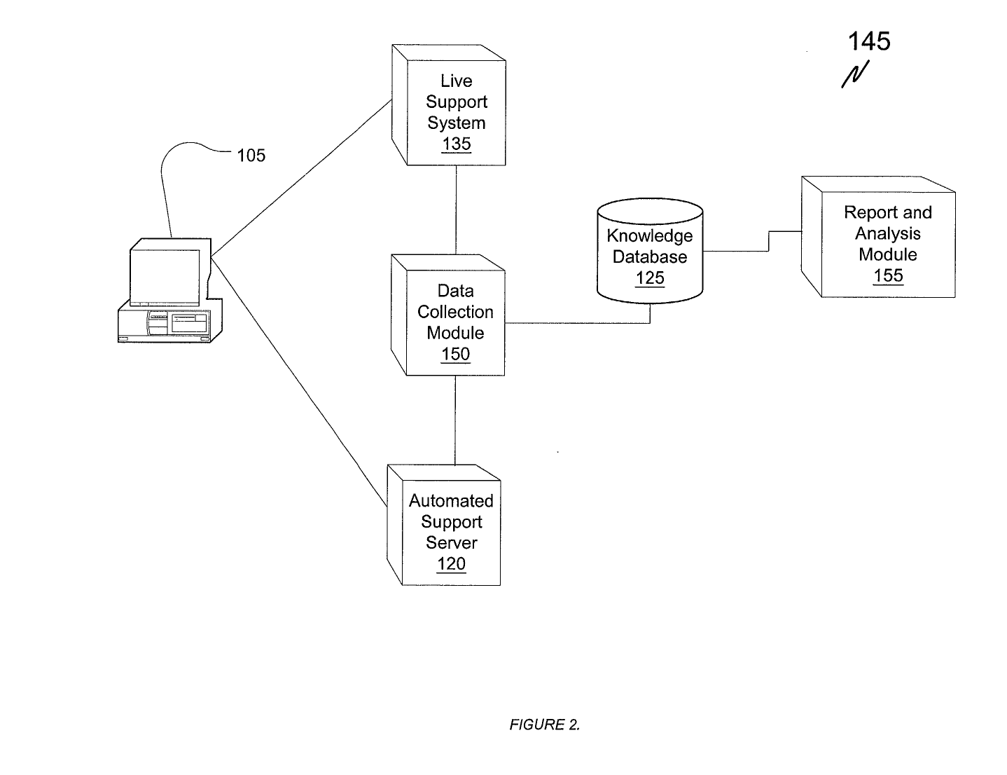

Referring now to FIG. 2, it illustrates another implementation of a system 145 constructed in accordance with the principles of the present invention. In this system 145, an end-user 105 can connect either to the live support system 135 (could also connect to the call center 130) or to the automated support server 120. Both systems 120 and 135 have access to the knowledge database, which as previously described, can contain information about the content provider's Web site, the end-user 105, and/or interaction management instructions. Thus, both the live support system 135 and the automated support system 120 have access to similar information when addressing an end-user's questions. For example, a live agent—through the live support system 135—could access the same set of interaction management instructions to address an end-user's question as would the automated agent—through the automated support server 120. Although the knowledge database 125 is shown as a single element, those of skill in the art can understand that the knowledge database 125 can be arranged in a variety of ways including a multi-device, distributed storage system and a multi-device independent storage system.

As (or after) the end-user 105 interacts with the live support system 135, data regarding the interaction can be collected and recorded in the data collection module 150 by the report and analysis module 155. This information can be analyzed to identify needed enhancements to the automated support server 155. For example, the report and analysis module 155 can determine that a new frequently asked question and its corresponding answer should be added to the knowledge database 125, thereby allowing the automated agent to answer that question without the aid of a live agent. In other implementations, the report and analysis module 155 can recommend enhancements to the live support system 135, network configurations, marketing tactics, automated agent presentations, etc. Additionally, the report and analysis module 155 can track usage of the automated support server 120 and/or live support system 135 for modeling and/or billing purposes.

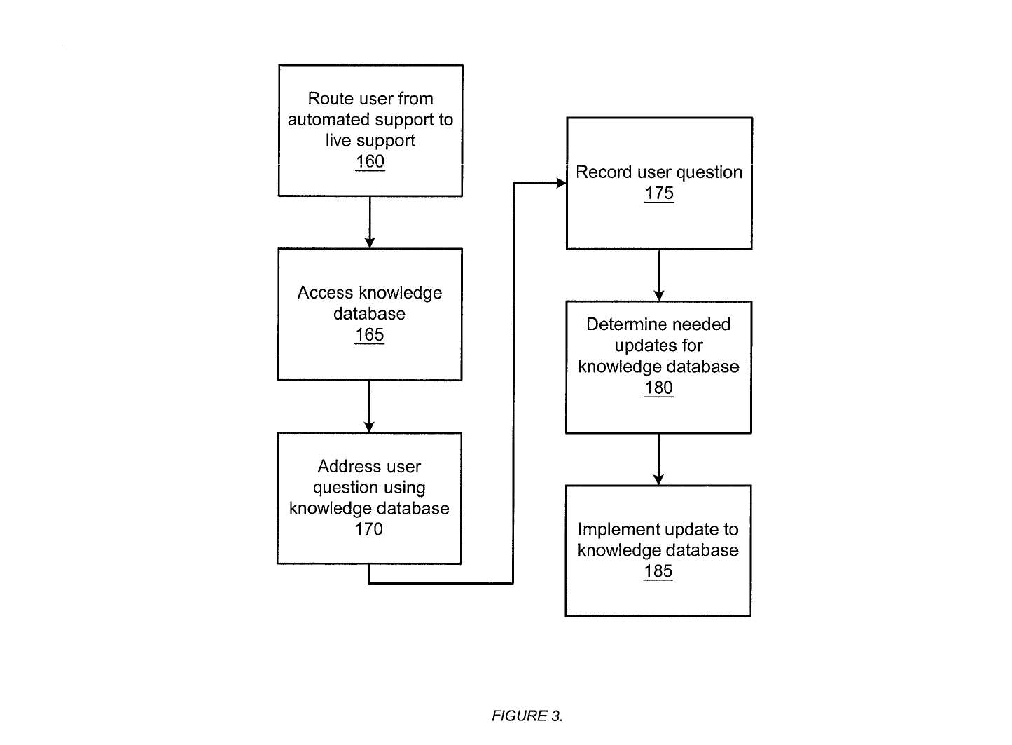

Referring now to FIG. 3, it shows a method of operating the system 145 shown in FIG. 2. In this implementation, an end-user 105 is routed from the automated agent at the automated support server 120 to a live agent at the live support system 135 (step 160). The live support system 135 then accesses the knowledge database 125 and retrieves any information relating to the end-user 105, the user's interaction with the automated agent, and/or the user's present location within the content provider's Web site (step 165). Alternatively, the automated support server 120 could initiate the transfer of this data to the live support system 135. In either case, the data available to the automated agent is generally available to the live agent. If not available in the retrieved information, the live agent determines the user's questions and addresses them according to either an interaction management plan—possibly stored in the knowledge database 125—or personal experience (step 170).

The end-user's question, its answer, and any appropriate comments can then be recorded in the data collection module 150 (step 175). When a meaningful sample of questions has been collected, the report and analysis module 155 can retrieve necessary data from the data collection module 150 and determine if any of the questions being handled by the live support system 135 are better suited for the automated support server 120 (step 180). If so, an update for the automated support server 120 is identified and implemented (step 185). Likewise, the report and analysis module can create an improved plan for live agents to address particular questions.

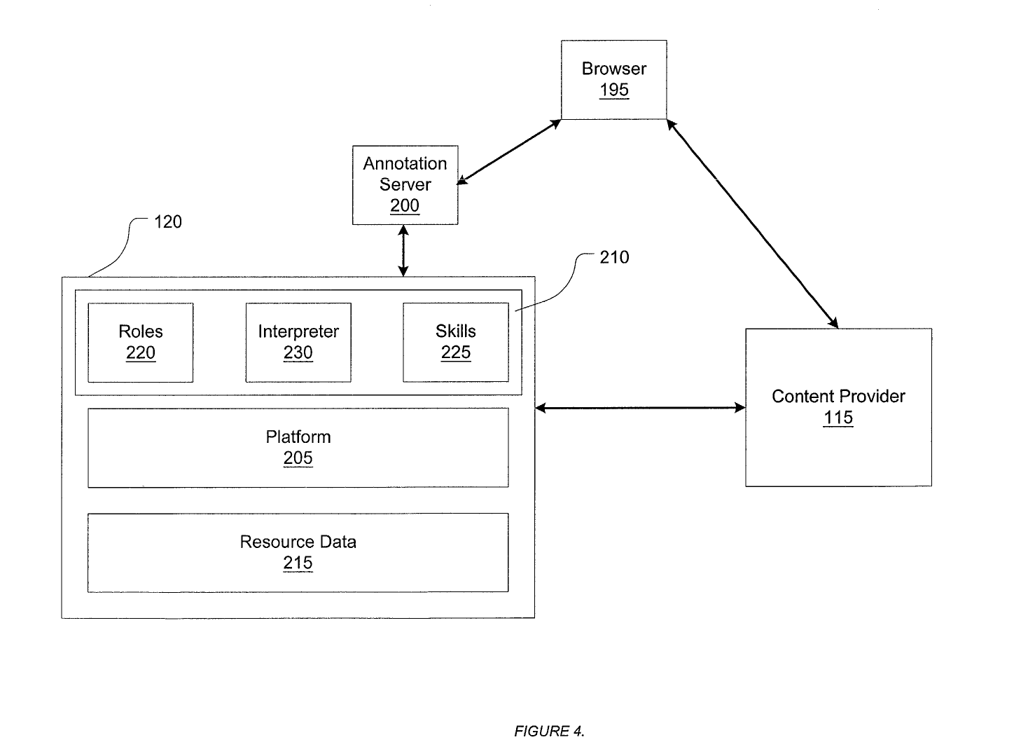

Referring now to FIG. 4, it illustrates an alternate implementation of a system 190 constructed in accordance with the principles of the present invention. This embodiment includes a Web browser 195 (representing the end-user 105) connected to the content provider 115 and the automated support server 120. The browser 195 is also connected to an annotation server 120 that is responsible for masking addresses so that the automated agent and the content from the content provider 115 can appear simultaneously within a single browser frame set and exchange information despite the fact that the automated agent and the content, from the content provider 115, originate from different domains. Moreover, the automated agent can manifest itself in the browser window using a variety of ways including a Java applet, a flash player, or traditional HTML techniques.

Still referring to FIG. 4, the automated support server 120 of this implementation includes three basic components: a platform 205, a profiler application 210, and resource data 215. The automated support server 120 can be implemented on many types of hardware including Sun Microsystems based systems, Microsoft based systems, and Linux based systems. Additionally, the various components of the automated support server can be distributed across one or more hardware platforms or otherwise arranged in a distributed fashion.

The profiler application 210 of the automated support server 120 includes a roles module 220, a skills module 225, and an interpreter module 230. The roles module 220 includes reusable definitions for each role that an automated agent can be assigned. Similarly, the skills module 225 includes the definitions for each skill that can be assigned to a role. The interpreter module 230 is responsible for invoking the appropriate role and skill in response to end-user 105 initiated events. For example, the interpreter module 230 could initially invoke a greeting role for the automated agent and assign the appropriate skills to that role.

The actual character definitions, social rules, character dialogue, and other relevant data are contained in the resource data module 215, which generally corresponds to at least portions of the knowledge database 125 of FIG. 1. To execute a particular skill, the platform 205 bridges between the profiler application and the resource data module 215 to retrieve the necessary data. For example, one dialogue contained in the resource data 215 could be called “formal greeting” and be associated with the phrase “Hello Sir, I will be your guide today,” and another dialogue could be called “informal greeting” and be associated with the phrase “Let me show you around.” The same role, “site orientation.,” and the same skill, “speak greeting,” could invoke either dialogue based upon data about the end-user 105. In other words, if the end-user 105 is, for example, under 30 then the “speak greeting” skill could use the informal greeting. Otherwise the “speak greeting” skill could use the formal greeting. By modularizing the profiler application 210 and the resource data 215 in this way, the automated agent can be easily adapted to handle new roles, new skills, new dialogue, and new visual characteristics. Additionally, this type of modularization allows for an automated support server 120 to be quickly and efficiently customized for different content providers.

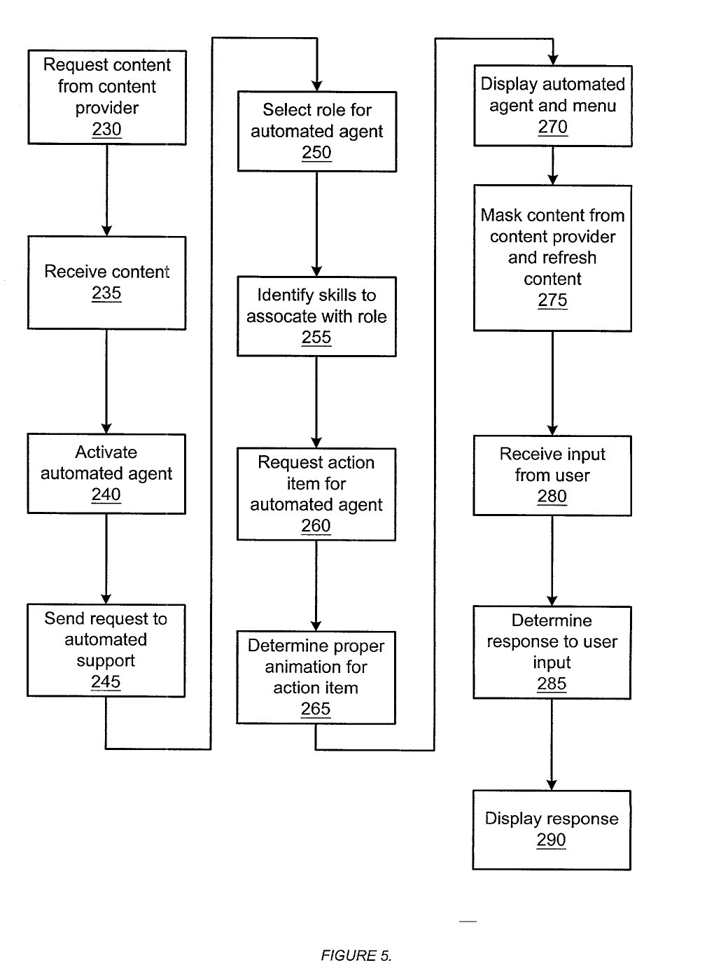

Referring now to FIG. 5, it is a flowchart of one method of operating the system shown in FIG. 4. In this implementation, an end-user 105, through a browser 190, requests and receives content from the content provider 115 (steps 230 and 235). This content generally includes a link—possibly in the form of an icon—to the automated agent. When in need of assistance, the end-user 105 selects the link to the automated agent, and, in response, the browser 195 sends a fetch request to the automated support server 120 for the data associated with the automated agent (steps 240 and 245). Next, the automated support server 120 identifies the appropriate role for the automated agent and loads the skills associated with that role (steps 250 and 255). Next, the action item for the automated agent is identified (step 260). For example, the action item could be to invoke the “look busy” skill. The automated support server 120 can then use the action item, role, and/or skills to determine the proper animation for the automated agent and display the automated agent along with the proper animation on the browser window (steps 265 and 270).

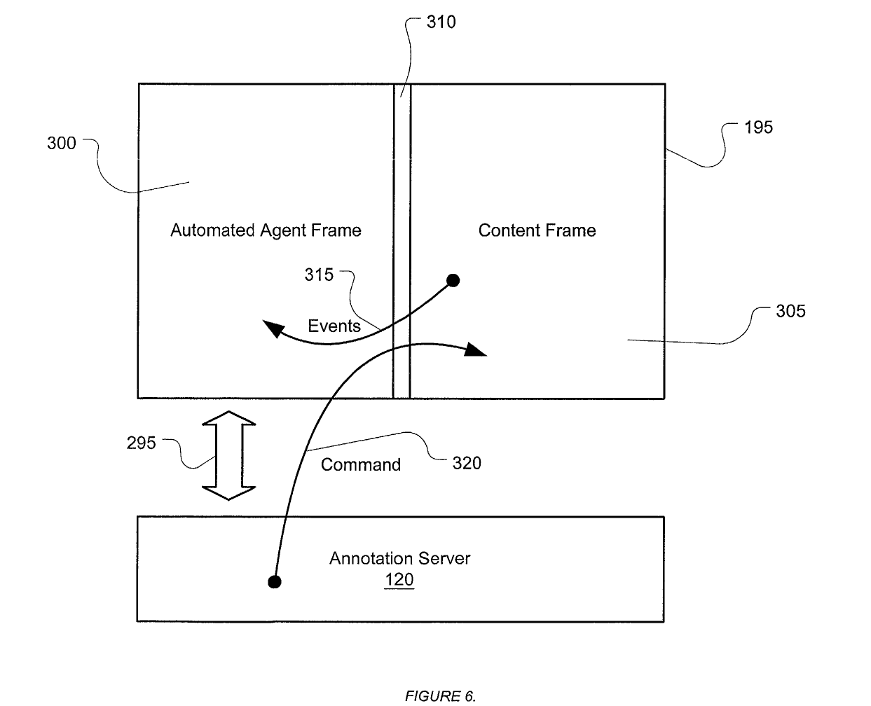

Additionally, the automated support server 120 can cause the content from the content provider 115 to be refreshed (step 275). However, to circumvent the consistent page domain security requirement, the annotation server 200 masks the content from the content provider 115 so that it appears to originate from the same domain as the automated agent (step 275). This masking process is described in greater detail with relation to FIG. 6.

In addition to displaying the automated agent alongside the content from the content provider 115, the automated support server 120 can also display a list of options on the browser window from which the end-user 105 can choose. Responsive to the end-user 105 choosing one of the listed options, the automated support server 120 can access the resource data 215 within the automated support server 120 and determine the proper response (steps 280 and 285). That response can be displayed in the browser window (step 290).

Referring now to FIG. 6, it illustrates the interaction of the annotation server 120 and the browser 195, which can communicate with each other, for example, through HTTP tunneling 295. In this embodiment, the browser 195 displays two frames: the automated support frame 300 and the content frame 305. Other frames could be used to display menus and/or dialogue associated with the automated agent. Separator 310 represents the consistent page domain security requirement that prevents the free flow of data and event information between the two frames.

By circumventing the consistent page domain security requirement, the annotation server 120 allows data to be exchanged by the frames even though they originate from different domains. (As previously described, the automated agent generally originates from the automated support server's domain and the content frame originates from the content provider's domain.) First, event information 315 can be passed from the content frame 305 to the automated agent frame 300. For example, if the end-user 105 selects a link being displayed in the content frame 305, corresponding event information 315 can be passed from the content frame 305 to the automated agent frame 300 where it is available to the annotation server 120 and the automated agent. Second, commands 320 can be passed from the annotation server 120 to the content frame 305. For example, the automated agent (or live agent) can actively guide the end-user 105 by following links being displayed in the content frame 305.

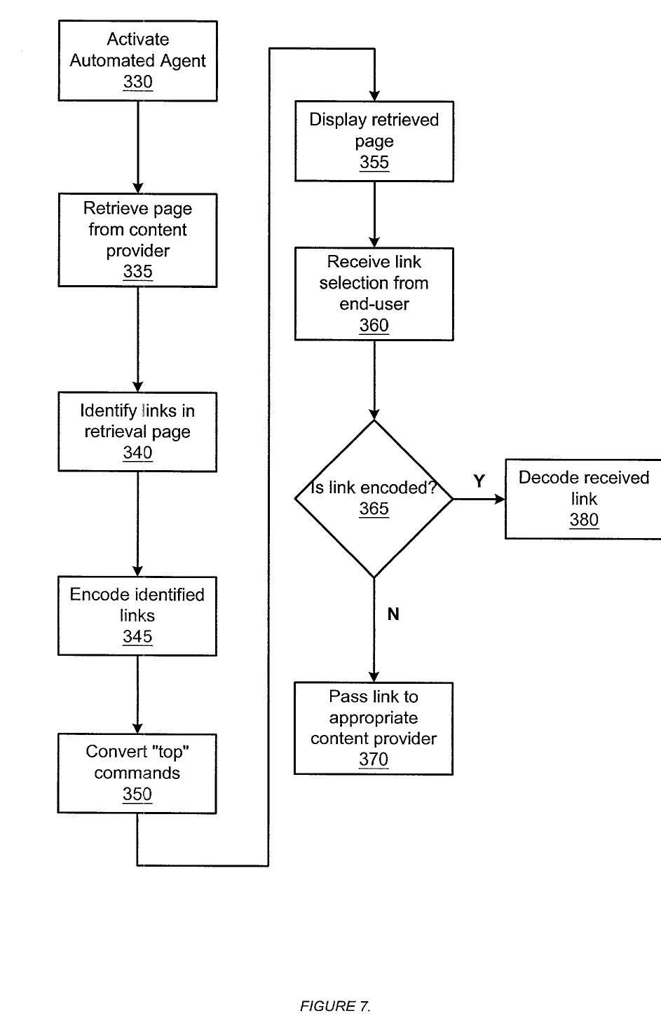

The role of the annotation server 120 in enabling these two types of data exchanges is illustrated by the flowchart in FIG. 7. Initially, the end-user 105, through the browser 195, activates the automated agent (step 330). Next, the annotation server 120 retrieves from the content provider 115 the page presently being displayed in the content frame 305 and identifies each link in that retrieved page (steps 335 and 340). The annotation server 120 encodes the identifier for the retrieved page and each link in the same domain as the retrieved page to appear as if they originate from the automated support server 120. In other words, the annotation server 120 encodes the links as if they originated from the same domain as the automated agent (step 345). Any “top” commands associated with the retrieved page are converted so that the automated agent frame 300 and the content frame 305 appear simultaneously within the browser window (steps 350 and 355).

When the end-user 105 selects a link (step 360) within the content frame 305 the annotation server determines if the link is encoded (step 365). Assuming that the link was previously encoded, a corresponding fetch request 120 is sent to the annotation server 120 rather than to the content provider 115 (step 360). The annotation server 120 then decodes (step 380) the link and forwards the fetch request to the content provider 115. The content provider 115 returns the requested page to the annotation server 120 (step 335), which encodes the identifier of the returned page and identifies and encodes the appropriate links in the returned page (steps 340 and 345). When the end-user 105 selects a link that was not previously encoded, the corresponding fetch request is routed according to the link and is not necessarily routed the annotation server 120 (step 370).

In an alternate embodiment, links associated with the automated agent and its menus can be encoded so that their domain matches the domain of the content from the content provider. Moreover, encoding can be avoided if the automated agent is hosted by the content provider. In such an implementation, both the automated agent and the content could originate from the same domain.

In conclusion, the present system provides, among other things, a system and method for displaying content in a browser window associated with an end-user is described. Those skilled in the art, however, can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for operating a browser associated with an end-user, the method comprising:
retrieving content from a content provider that corresponds to a navigation location, wherein the retrieved content includes an embedded navigation link;
encoding the embedded navigation link;
replacing the embedded navigation link included in the retrieved content with the encoding of the embedded navigation link; and
providing modified content to the end-user, wherein the modified content includes at least a portion of the retrieved content and includes the encoding of the embedded navigation link that replaced the embedded navigation link.

2. The method of claim 1, wherein providing the end-user support comprises:
providing secondary content to the user generally simultaneously with providing the modified content.

3. The method of claim 2, wherein the secondary content is associated with a first domain and the modified content is associated with a second domain, and wherein encoding the embedded navigation link comprises:
changing one of the first domain and the second domain so that the secondary content and the modified content appear to originate from a common domain.

4. The method of claim 1, further comprising:
receiving at least an indication of a selection of the encoded navigation link;
decoding the at least an indication of the encoded navigation link; and
retrieving content corresponding to the decoded at least an indication of the encoded navigation link.

5. A method for making event information associated with a first frame of a web browser available to a second frame of the web browser, wherein a first content originating from a first domain is associated with the first frame and a second content originating from a second domain is associated with the second frame, the method comprising:
receiving the first content, the first content including a plurality of navigation links;
identifying a first of the plurality of navigation links;
encoding the first of the plurality of navigation links to appear as if it originates from the second domain;
generating a modified content by replacing the first of the plurality of navigation links with the encoding of the first of the plurality of navigation links; and
providing the modified content to the first frame of the web browser.

6. The method of claim 5, further comprising:
receiving, at the second frame, an indication of a selection of the encoding of the first of the plurality of navigation links.

7. The method of claim 6, further comprising:
passing the indication of a selection of the encoding of the first of the plurality of navigation links from the first frame to the second frame.

8. The method of claim 5, wherein the first of the plurality of navigation links is associated with the first domain.

9. The method of claim 5, further comprising:
identifying a second navigation link, wherein the second navigation link is associated with a third domain, the third domain being different than the first domain;
wherein the modified content comprises at least a portion of the first content, the encoding of the first of the plurality of navigation links, and a non-encoded second navigation link.

10. The method of claim 5, further comprising:
passing an event indicator from the first frame to the second frame.

11. A system for operating a browser associated with an end-user, the system comprising:
a processor;
a storage device connected to the processor;
a plurality of instructions stored on the storage device, the plurality of instructions configured to cause the processor to:
retrieve content from a content provider that corresponds to a navigation location, wherein the retrieved content includes an embedded navigation link;
encode the embedded navigation link;
replace the embedded navigation link included in the retrieved content with the encoding of the embedded navigation link; and
provide modified content to the end-user, wherein the modified content includes at least a portion of the retrieved content and includes the encoding of the embedded navigation link that replaced the embedded navigation link.

12. The system of claim 11, wherein the plurality of instructions are configured to cause the processor to provide the end-user support by:
providing secondary content to the user generally simultaneously with providing the modified content.

13. The system of claim 12, wherein the secondary content is associated with a first domain and the modified content is associated with a second domain, and wherein the plurality of instructions are configured to cause the processor to encode the embedded navigation link by:
changing one of the first domain and the second domain so that the secondary content and the modified content appear to originate from a common domain.

14. The system of claim 1, wherein the plurality of instructions are configured to cause the processor to:
receive at least an indication of a selection of the encoded navigation link;
decode the at least an indication of the encoded navigation link; and
retrieve content corresponding to the decoded at least an indication of the encoded navigation link.

15. A system for making event information associated with a first frame of a web browser available to a second frame of the web browser, wherein a first content originating from a first domain is associated with the first frame and a second content originating from a second domain is associated with the second frame, the system comprising:
means for receiving the first content, the first content including a plurality of navigation links;
means for identifying a first of the plurality of navigation links;
means encoding the first of the plurality of navigation links to appear as if it originates from the second domain;
means for generating a modified content by replacing the first of the plurality of navigation links with the encoding of the first of the plurality of navigation links; and
means for providing the modified content to the first frame of the web browser.

16. The system of claim 15, further comprising:
means for receiving, at the second frame, an indication of a selection of the encoding of the first of the plurality of navigation links.

17. The system of claim 16, further comprising:
means for passing the indication of a selection of the encoding of the first of the plurality of navigation links from the first frame to the second frame.

18. The system of claim 15, further comprising:
means for identifying a second navigation link, wherein the second navigation link is associated with a third domain, the third domain being different than the first domain;
wherein the modified content comprises at least a portion of the first content, the encoding of the first of the plurality of navigation links, and a non-encoded second navigation link.

19. The system of claim 15, further comprising:
means for passing an event indicator from the first frame to the second frame.
